(19) United States
(12) Patent Application Publication
(10) Pub. No.: US 2023/0187734 A1
(43) Pub. Date: Jun. 15, 2023

(54) THERMAL BATTERY MANAGEMENT SYSTEM

(71) Applicant: Green Cubes Technology, LLC, Kokomo, IN (US)

(72) Inventors: Mohammed Alobaidi, Kokomo, IN (US); Steve Butler, Kokomo, IN (US); Joseph Richards, Kokomo, IN (US)

(73) Assignee: Green Cubes Technology, LLC, Kokomo, IN (US)

(21) Appl. No.: 17/919,371

(22) PCT Filed: Apr. 16, 2021
(86) PCT No.: PCT/US21/27708

§ 371 Date: Oct. 17, 2022

Related U.S. Application Data
(60) Provisional application No. 63/011,650, filed on Apr. 17, 2020.

(51) Int. Cl. H01M 10/6569; H01M 10/613; H02J 7/00; H01M 10/0525

(52) U.S. Cl. CPC H01M 10/6569; H01M 10/613; H02J 7/00309; H01M 10/0525; H01M 2010/4271

(57) ABSTRACT

Disclosed herein are lithium iron phosphate (LiFePO₄) batteries, devices, systems, and methods for operating same. A battery management system (BMS) may be configured to monitor and control heating and cooling elements within the battery. The at least one battery pack may have battery cells and harnessing disposed therein, as well as at least one temperature control element configured to absorb heat and/or exhaust heat from within the battery to outside the battery to decrease and/or increase temperature within the battery. Also disclosed herein are batteries having phase change materials (PCM), heating element(s), and/or thermal electric device(s) disposed therein and configured to maintain internal temperature of the battery at an optimal range for uninterrupted battery operations.

### PRIORITY

The present application is related to, and claims the priority benefit of, U.S. Provisional Patent Application Ser. No. 63/011,650, filed Apr. 17, 2020, the contents of which are incorporated herein directly and by reference in their entirety.

### BACKGROUND

The wide range of global environmental temperatures can often exceed the normal operating range of a typical lithium battery, such as a lithium battery having a lithium iron cell chemistry. When temperatures exceed the normal operating range of a lithium battery, the battery life can be seriously decreased, damaged, and/or can be ruined beyond repair. The extreme temperatures can also decrease overall battery performance and charging capability, such as in large electric vehicle batteries.

In the past, lithium batteries have not been used in these extremely hot or cold environments and people have instead managed with substitutes, such as internal combustion engines that run on diesel fuel, or lead acid batteries. In some cases, such as in very cold environments, the flooded lead acid battery design of electric vehicles would stop operating at low temperatures due to frozen electrolyte. Often, the electrolyte in an electric vehicle battery will become ‘sluggish’ when the temperature begins to drop much below 40° F. When this happens, the useable life of the lithium battery would be greatly impacted due to the damage caused by the extreme temperature.

However, lithium iron phosphate, or LiFePO₄, batteries are tougher and provide more power and capacity, than lead acid batteries, except at extreme temperatures. The LiFePO₄ batteries can sometimes even provide up to ten times the number of battery cycles, at a quarter of the weight, of a traditional lead acid battery. It would certainly be desirably to have a tougher, higher power and capacity LiFePO₄ battery capable of reliably operating at either extremely high, or extremely low, temperatures without causing damage to the battery.

### BRIEF SUMMARY OF THE INVENTION

The present disclosure includes disclosure of a lithium iron phosphate battery (LiFePO₄) battery, comprising: a battery management system (BMS) configured to monitor and control heating and cooling elements within the battery; at least one battery pack having cells and harnessing disposed therein; and at least one temperature control element configured to absorb heat and/or exhaust heat from within the battery to outside the battery to decrease and/or increase temperature within the battery.

The present disclosure also includes disclosure of the battery, wherein the at least one temperature control element is selected from the group comprising: a heating and/or cooling element(s), phase change materials (PCMs) and/or their container(s), heat exchanger(s), thermal electric device(s) or element(s), and/or thermal electric cooler(s).

The present disclosure also includes disclosure of the battery wherein the PCMs and/or their containers are configured to absorb heat during high temperature conditions.

The present disclosure also includes disclosure of the battery wherein the at least one heat exchanger and/or thermal electric device and the PCMs maintain an optimal temperature within the battery for uninterrupted operation of the battery.

The present disclosure also includes disclosure of the battery wherein the optimal temperature within the battery may be maintained in a range of 5° C. to 40° C.

The present disclosure also includes disclosure of the battery wherein the PCMs may comprise hydrated sodium and/or organic acid.

The present disclosure also includes disclosure of the battery wherein the at least one heat exchanger may comprise a plurality of heat exchangers arranged in series.

The present disclosure also includes disclosure of the battery wherein the at least one thermal electric device comprises a thermal electric cooler.

The present disclosure also includes disclosure of the battery wherein the thermal electric cooler is used when the optimal temperature becomes too high.

The present disclosure also includes disclosure of the battery wherein the PCMs operate as a state catalyst.

The present disclosure also includes disclosure of the battery wherein the PCMs are modular to provide a number of different configurations within the battery.

The present disclosure also includes disclosure of the battery wherein the PCMs are recharged by forcing a phase change wherein cool air is flowed over the PCMs using the fan.

The present disclosure also includes disclosure of a lithium iron phosphate battery (LiFePO₄) battery, comprising: a battery management system (BMS) configured to monitor and control heating and cooling elements within the battery; at least one battery pack having cells and harnessing disposed therein; and at least one PCM, heating element, and/or thermal electric device disposed therein and configured to maintain internal temperature of the battery at an optimal range for uninterrupted battery operations.

The present disclosure also includes disclosure of the battery, wherein the at least one PCM may comprise modular containers having hydrated sodium and/or organic acid therein.

The present disclosure also includes disclosure of the battery, wherein the at least one thermal electric device comprises a thermal electric cooler.

The present disclosure also includes disclosure of the battery, wherein the thermal electric cooler is used in addition to the at least one PCM when the optimal range for uninterrupted battery operations becomes too high/hot.

The present disclosure also includes disclosure of the battery, wherein the optimal range for uninterrupted battery operations is between of 5° C. to 40° C.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 illustrates an exemplary battery thermal management system.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes various lithium iron phosphate battery (LiFePO₄) batteries having battery management systems (BMS), heating elements, heat exchangers, fans, thermal electric devices or coolers, and/or phase change material (PCM's) that manage cyclic phase change with outside catalysts to allow for operation of the lithium iron phosphate battery (LiFePO₄) in a wider range of environmental temperature conditions (i.e., extreme hot or cold). The lower weight and longer life of lithium iron phosphate LiFePO₄ batteries (also known as LFPs) make them an ideal and safe choice for bicycles and electric vehicles, except at extremely hot or cold environmental temperatures, when battery performance is decreased.

The lithium iron phosphate (LiFePO₄) batteries disclosed herein may comprise internal thermal or temperature BMS to improve battery performance in such extreme temperature environments. For example, the BMS may operate as a thermal or temperature management system to monitor and control the activation and deactivation of the heating and cooling elements within the battery to maintain an optimal internal temperature for uninterrupted battery operations.

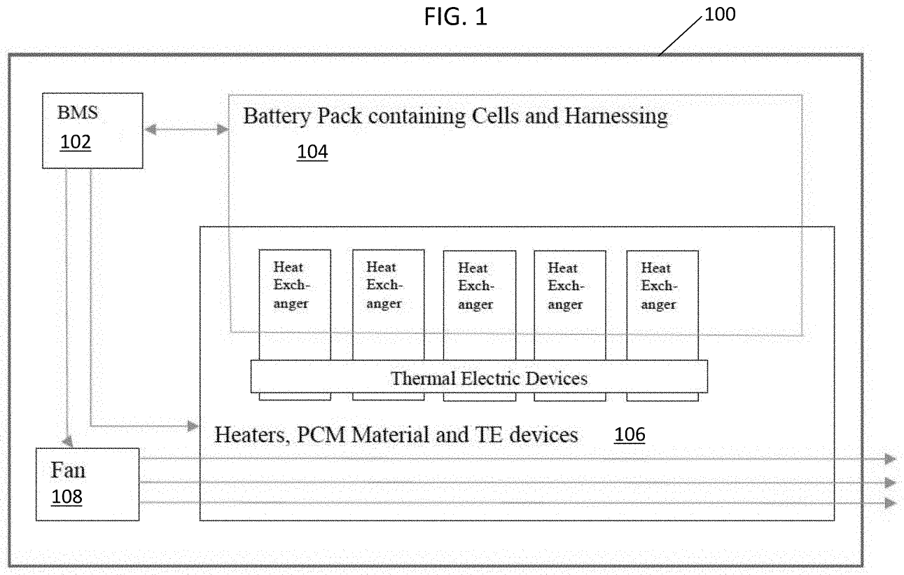

A first embodiment, shown in FIG. 1, illustrates an exemplary lithium iron phosphate battery (LiFePO₄) 100 having a BMS 102 operable to monitor and regulate temperature within the battery 100. The BMS 102 may be operably coupled to the battery pack 104 containing the battery cells and harnessing, as shown in FIG. 1, as well as to temperature control elements 106 (shown generally as 106 in FIG. 1), which can be one or more of a heating and/or cooling element(s), phase change materials (PCMs) and/or their container(s), heat exchanger(s), thermal electric device(s) or element(s), thermal electric cooler(s) etc. (all collectively referred to as 106 herein) within the battery.

In high/hot temperature condition environments, the internal battery temperature may be managed by cooling the inside of the battery 100. Specifically, the inside of the battery 100 may be cooled by using PCMs 106 to manage cyclic phase changes and/or as a state catalyst. The PCMs 106 may absorb heat during increased temperature conditions. In addition to the PCMs 106, at least one heat exchanger 106 with a fan 108, and/or a thermal electric device 106, such as a thermal electric cooler 106, may also be used to exhaust the heat from within the battery 100 to the outside environment. In these embodiments, it should be understood that any number, size, shape, and configuration of temperature control elements 106 (such as heating exchangers 106, fans 108, and/or thermal electric devices 106) may be used, depending upon the battery size, operating environment, and/or customer requirements. In these very hot environments, heating within the battery 100 may be used and/or initiated in temperatures above 40° C., for example. However, it should be understood that these embodiments may be implemented in batteries at any desired environmental temperature.

In some exemplary embodiments, the PCMs 106 may comprise common modular containers filled with hydrated sodium, or an organic acid, to absorb (or otherwise maintain) heat. These PCMs 106 may be modular such that they can comprise any number, size, or arrangements of containers, thus providing the flexibility to have any configuration and be built into any sized battery 100. Different quantities of PCMs 106 and/or PCM containers 106 may be required to meet specific environmental and battery 100 use cases. Once an exemplary PCM or PCM container 106 has absorbed its heat capacity, the PCMs and/or PCM containers 106 may be recharged, such as by forcing a phase change by flowing cool air over the PCMs and/or PCM containers 106 with the fan 108. When the battery temperature 100 is high enough, thermal electric cooler 106 may also be used to exhaust or remove heat from the battery 100 (i.e., to lower the internal battery 100 temperature).

In low/cold temperature condition environments, the internal battery temperature may be managed by heating the inside of the battery 100. Specifically, the inside of the battery 100 may be heated using one or more heating elements, to generate heat and keep the internal temperature of the battery in an optimal temperature range for uninterrupted operation. In this matter, the lithium iron phosphate battery (LiFePO₄) battery can be improved to eliminate ‘sluggish’ or frozen electrolytes in cold temperature environments. It should be understood that there may be any number, size, shape, and arrangement of heating elements self-contained within the battery, depending upon the used, depending upon the battery size, operating environment, and/or customer requirements. In these very cold environments, heating within the battery 100 may be used and/or initiated in temperatures below 5° C., for example. However, it should be understood that these embodiments may be implemented in batteries at any desired environmental temperature.

In exemplary operation, the PCMs 106 may begin to change phase and absorb heat at the PCMs specified temperature (as per PCM 106 material specifications). In one exemplary method of operation, the BMS 102 may control the fan(s) 108 and thermal electric cooler(s) 106 to manage phase change cycle recharging to allow the PCMs 106 to absorb heat in subsequent cycles.

While various embodiments of devices and systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A lithium iron phosphate battery (LiFePO₄) battery, comprising:
a battery management system (BMS) configured to monitor and control heating and cooling elements within the battery;
at least one battery pack having cells and harnessing disposed therein;
phase change materials (PCMs); and
at least one temperature control element configured to absorb heat or exhaust heat from within the battery to outside the battery or to generate heat in order to decrease or increase temperature within the battery, respectively.

2. The battery of claim 1, wherein the at least one temperature control element is selected from the group comprising: heating element(s), cooling element(s), heat exchanger(s), thermal electric device(s) or element(s), or thermal electric cooler(s).

3. The battery of claim 2, wherein the PCMs and their containers are configured to absorb heat during high temperature conditions.

4. The battery of claim 2, wherein the at least one temperature control element further comprises:
the heat exchanger(s) or the thermal electric device(s), and
wherein the PCMs and the at least one temperature control element are configured to maintain an optimal temperature within the battery for uninterrupted operation of the battery.

5. The battery of claim 4, wherein the optimal temperature within the battery may be maintained in a range of 5° C. to 40° C.

6. The battery of claim 2, wherein the PCMs may comprise hydrated sodium and/or organic acid.

7. The battery of claim 2, wherein the at least one temperature control element comprises at least one heat exchanger with a fan and further comprises a plurality of heat exchangers arranged in series.

8. The battery of claim 7, wherein the at least one temperature control element further comprises at least one thermal electric device comprising a thermal electric cooler.

9. The battery of claim 8, wherein the thermal electric cooler is used when an optimal temperature becomes too high.

10. The battery of claim 2, wherein the PCMs operate as a state catalyst.

11. The battery of claim 2, wherein the PCMs are modular to provide a number of different configurations within the battery.

12. The battery of claim 7, wherein the PCMs are recharged by forcing a phase change wherein cool air is flowed over the PCMs using the fan.

13. A lithium iron phosphate battery (LiFePO₄) battery, comprising:
a battery management system (BMS) configured to monitor and control heating and cooling elements within the battery;
at least one battery pack having cells and harnessing disposed therein; and
at least one PCM and a heating element, or a thermal electric device disposed therein and configured to maintain internal temperature of the battery at an optimal range for uninterrupted battery operations.

14. The battery of claim 13, wherein the at least one PCM may comprise modular containers having hydrated sodium and/or organic acid therein.

15. The battery of claim 13, wherein the at least one thermal electric device comprises a thermal electric cooler.

16. The battery of claim 15, wherein the thermal electric cooler is used in addition to the at least one PCM when the optimal range for uninterrupted battery operations becomes too high or hot.

17. The battery of claim 13, wherein the optimal range for uninterrupted battery operations is between 5° C. to 40° C.

18. A battery, comprising:
a battery management system (BMS) configured to monitor and control heating and cooling elements within the battery and to monitor and regulate a temperature within the battery, the battery being a lithium iron phosphate battery;
at least one battery pack having cells and harnessing disposed therein;
at least one phase change material (PCM);
a heat exchanger with a fan; and
a thermal electric cooler;
wherein the heat exchanger with a fan is controlled by the BMS to cool the PCM that has begun to absorb heat and phase change; and
wherein the thermal electric cooler is controlled by the BMS to exhaust or remove heat from the battery when the temperature of the battery is high enough.

19. The battery of claim 18, wherein the heat exchanger with a fan is contained within the battery and configured to flow cool air over the PCM.

20. The battery of claim 18, further comprising a heating element controlled by the BMS to generate heat and raise the temperature of the battery.
